(19) United States
(12) Patent Application Publication
(10) Pub. No.: US 2015/0365515 A1
(43) Pub. Date: Dec. 17, 2015

(54) METHOD OF TRIGGERING AUTHENTICATION MODE OF AN ELECTRONIC DEVICE

(71) Applicant: AirSig Inc., Grand Cayman (KY)

(72) Inventor: PO-KAI CHEN, Grand Cayman (KY)

(21) Appl. No.: 14/741,445

(22) Filed: Jun. 16, 2015

Related U.S. Application Data
(60) Provisional application No. 62/013,227, filed on Jun. 17, 2014.

(51) Int. Cl. H04M 1/725; H04W 4/00; H04W 4/02; H04W 12/06

(52) U.S. Cl. CPC H04M 1/72577; H04W 12/06; H04W 4/008; H04W 4/02

(57) ABSTRACT

A method of triggering identity authentication mode of an electronic device is disclosed. The method includes following steps: when a triggering event is detected, automatically entering identity authentication mode; accepting a user operation of a user under identity authentication mode; generating input data corresponding to the user operation; if the input data is determined matching one of a plurality of predefined input data established previously, authenticating the user identity, and obtaining a control command corresponding to the predefined input data; and executing the control command. With the method of the present invention, the electronic device automatically enters identity authentication mode when a triggering event is detected, which effectively simplified the operation required to enter the identity authentication mode.

### CROSS-REFERENCE TO RELATED APPLICATION

This patent application claims the benefit of U.S. Provisional Patent Application No. 62/013,227, filed Jun. 17, 2014, which is incorporated by reference herein.

### BACKGROUND OF THE INVENTION

1. Field of the Invention

The present invention relates to a triggering method, in particular relates to a triggering method of identity authentication mode in an electronic device.

2. Description of Prior Art

FIG. 1 is a flowchart of a method of triggering identity authentication mode in prior art. As shown in FIG. 1, when a user holds a smart phone and wants to use an application (for example an email application or a social network application), the user has to manually unlock a screen lock of the smart phone (step S10), manually launches the application after the smart phone is ready for executing operation (step S12). Next, the user inputs a launching identity authentication mode operation via a graphic user interface (GUI) offered by the application (for example click a logon key) so as to enable the smart phone to enter an identity authentication mode (for example display a logon screen) (step S14). Lastly, the user inputs an identity authentication operation under the identity authentication mode (for example inputs a password) to perform identity authentication (step S16). Also, the electronic device determines if the identity authentication operation is correct under the identity authentication mode, the user is permitted to control the application (for example view emails, or view new feeds in the social networks of the user).

As mentioned above, according to the method of triggering identity authentication mode in prior art, the user has to perform several operations (comprising unlock the screen lock, manually launch the application and manually input the launching identity authentication mode operation), so as to enable the electronic device to enter the identity authentication mode, and execute functions associated with identity authentication under the identity authentication mode, which is complicated. The above-mentioned method is inconvenient to the user operation and offers inferior user experiences.

### SUMMARY OF THE INVENTION

The objective of the present invention is to provide a method of triggering identity authentication mode of an electronic device wherein the electronic device automatically enters an identity authentication mode when a specific event is detected.

In order to achieve the above mentioned objective, the present invention provides a method of triggering an identity authentication mode of an electronic device, comprising following steps:

a) when detecting a triggering event, automatically entering the identity authentication mode;

b) accepting a user operation under the identity authentication mode;

c) generating input data corresponding to the user operation;

d) if the input data is determined matching one of a plurality of predefined input data established previously, authenticating a user identity, and obtaining a control command matching the predefined input data; and

e) executing the control command.

The present invention effectively simplified the operation required to enter identity authentication mode.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a flowchart of a method of triggering identity authentication mode of prior art;

FIG. 2 is an electronic device architecture diagram of the first embodiment according to the present invention;

FIG. 3 is a flowchart of the triggering method of the first embodiment according to the present invention;

FIG. 4A is a partial flowchart of the triggering method of the second embodiment according to the present invention;

FIG. 4B is the first schematic diagram of a triggering event of the second embodiment according to the present invention;

FIG. 4C is the second schematic diagram of a triggering event of the second embodiment according to the present invention;

FIG. 5A is a partial flowchart of the triggering method of the third embodiment according to the present invention;

FIG. 5B is the first schematic diagram of a triggering event of the third embodiment according to the present invention;

FIG. 5C is the second schematic diagram of a triggering event of the third embodiment according to the present invention;

FIG. 5D is the third schematic diagram of a triggering event of the third embodiment according to the present invention;

FIG. 6A is a partial flowchart of the triggering method of the fourth embodiment according to the present invention;

FIG. 6B is a schematic diagram of a triggering event of the fourth embodiment according to the present invention;

FIG. 7A is a partial flowchart of the triggering method of the fifth embodiment according to the present invention;

FIG. 7B is a schematic diagram of a triggering event of the fifth embodiment according to the present invention;

FIG. 8 is a partial flowchart of the triggering method of the sixth embodiment according to the present invention;

FIG. 9 is a partial flowchart of the triggering method of the seventh embodiment according to the present invention;

FIG. 10A is a partial flowchart of the triggering method of the eighth embodiment according to the present invention;

FIG. 10B is a schematic diagram of a triggering event of the eighth embodiment according to the present invention;

FIG. 11A is a partial flowchart of the triggering method of the ninth embodiment according to the present invention;

FIG. 11B is the first schematic diagram of a triggering event of the ninth embodiment according to the present invention;

FIG. 11C is the second schematic diagram of a triggering event of the ninth embodiment according to the present invention; and

FIG. 12 is a partial flowchart of the triggering method of the tenth embodiment according to the present invention.

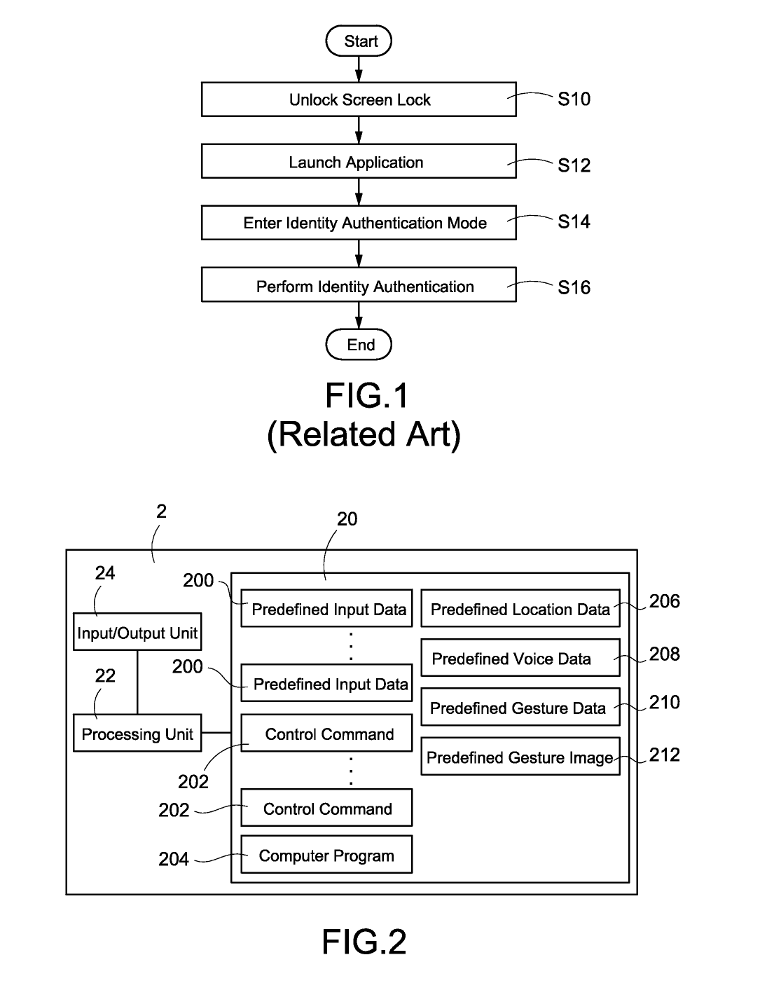

### DETAILED DESCRIPTION OF THE INVENTION

In cooperation with attached drawings, the technical contents and detailed description of the present invention are described thereinafter according to a preferable embodiment, being not used to limit its executing scope. Any equivalent variation and modification made according to appended claims is all covered by the claims claimed by the present invention.

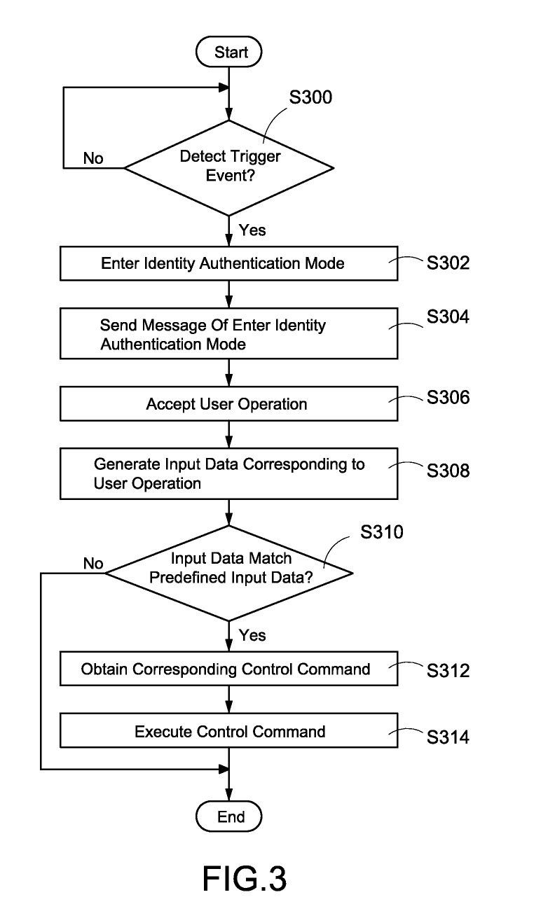

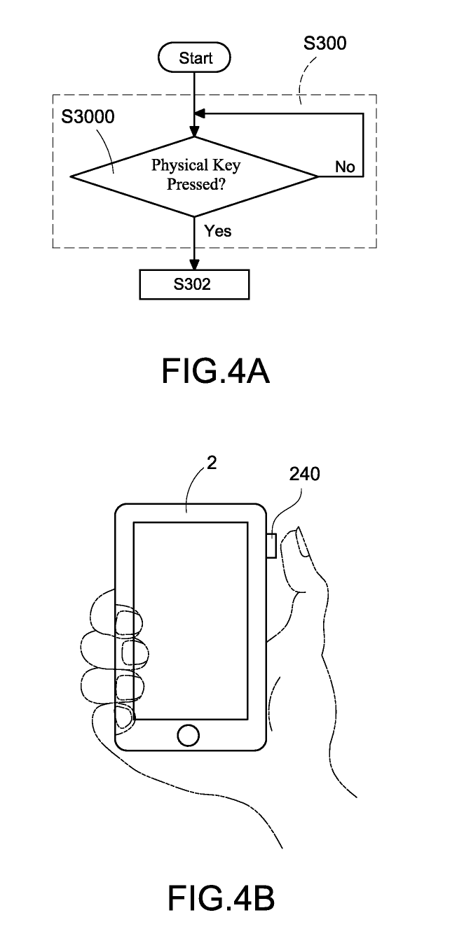

Refer to FIG. 2 and FIG. 3, FIG. 2 is an electronic device architecture diagram of the first embodiment according to the present invention, and FIG. 3 is a flowchart of the triggering method of the first embodiment according to the present invention.

As shown in FIG. 2, an electronic device 2 comprises a storage unit 20, a processing unit 22 and an input/output unit 24. Preferably, the electronic device 2 is a mobile device, such as a smart phone, a tablet, a notebook computer, a wearable device (for example a smart bracelet or a smart ring) or any combination of the above devices, but the scope is not limited thereto.

A plurality of predefined input data 200 and a plurality of control commands 202 are saved in the storage unit 20. The plurality of predefined input data 200 respectively corresponds to the plurality of control commands 202. The plurality of control command and 202 are respectively used for implementing a function of the electronic device 2 (for example launching a predefined application and/or executing predefined device control).

The processing unit 22 electrically connects to the storage unit 20 and the input/output unit 24, and is used for controlling each component of the electronic device 2.

The input/output unit 24 is used for accepting a user operation from a user, and providing feedback information to the user (for example displaying a picture or play sounds).

Preferably, the input/output unit 24 is a writing input device (for example an electronic pen or a touchpad), an audio input device (for example a microphone), an image device (for example a camera, a visible light camera or an infrared camera), a sensor (for example a motion sensor), an object identification device (for example a wired smart card reader, a wireless smart card reader (for example a RFID card reader or an NFC card reader) or a barcode scanner), a human machine interface (for example a touchscreen, a speaker, a keyboard or a mouse) or any combination of the above devices, but the scope is not limited thereto.

The embodiments of the method of triggering identity authentication mode of an electronic device (referred as the triggering method in the following description) are used in the electronic device 2 shown in FIG. 2. Specifically, a computer program 204 is further saved in the storage unit 20. After the processing unit 22 executes the computer program 204, each step of triggering method in each embodiment is executed.

In the embodiment, the triggering method comprises following steps:

Step S300: the electronic device 2 detects whether a triggering event occurs via the input/output unit 24 (such as detecting control from the user via the Human Machine Interface, or detecting the user hold/move the electronic device 2 via the sensor etc.). If the electronic device 2 detects the triggering event occurs, the electronic device 2 executes step S302. Otherwise, repeatedly executes the step S300 to continue to detect.

It should be noted that, in the embodiment, the computer program 204 of the electronic device 2 is predefined to be, but not limited to, a resident executive program under power on status, and continues to detect whether the triggering event occurs under the power on status of the electronic device 2, and executes the step S302 immediately when it detects the triggering event occurs. Also, the electronic device 2 can be configured to execute the computer program 204 after accepting the user's trigger command, but the scope is not limited thereto.

Step S302: the electronic device 2 automatically enters an identity authentication mode to enable function associated with the identity authentication.

Step S304: after the electronic device 2 successfully enters the identity authentication mode, the electronic device 2 sends a message of entering identity authentication mode via the input/output unit 24 (such as sending a warning sound, displaying a warning dialog box or vibrating).

It should be noted that, the step S304 is used for reminding the user that the electronic device 2 has entered into the identity authentication mode, and the step S304 is not a required step of implementing the triggering method in the embodiment. In another embodiment of the present invention, the electronic device 2 is not required to execute the step S304.

Step S306: the electronic device 2 accepts the user operation via input/output unit 24. Preferably, the user operation corresponds to the function which the user wants to execute.

Step S308: the electronic device 2 generates input data corresponding to the user operation. Preferably, the electronic device 2 generates the input data corresponding to the user operation and readable by the computer according to the accepted user operation.

Step S310: the electronic device 2 determines whether the input data matches one of the plurality of predefined input data 200. Preferably, the plurality of predefined input data 200 was previously saved in the storage unit 20 by the user, and respectively corresponds to different control commands 202.

If the electronic device 2 determines that the input data matches one of the plurality of predefined input data 200, the user identity is authenticated, and the electronic device 2 executes step S312 at the same time. Otherwise, the input/output unit 24 sends warnings and the method of activate-upon-authentication is terminated. That is, the authentication of the user identity fails, and the electronic device 2 is not allowed to execute any function.

Step S312: the electronic device 2 obtains the control command 202 corresponding to the predefined input data 200.

Step S314: the electronic device 2 executes the obtained control command 202 for the function which the user wants to execute.

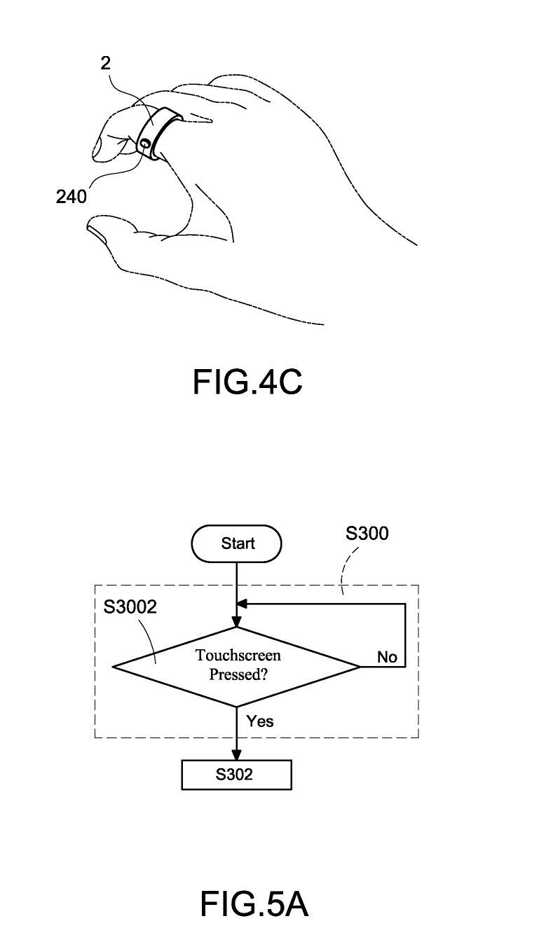

Refer to FIG. 4A, FIG. 4B and FIG. 4C, FIG. 4A is a partial flowchart of the triggering method of the second embodiment according to the present invention; FIG. 4B is the first schematic diagram of a triggering event of the second embodiment according to the present invention; and FIG. 4C is the second schematic diagram of a triggering event of the second embodiment according to the present invention.

The difference between the present embodiment and first embodiment is that the input/output unit 24 comprises a physical key 240 in the present embodiment.

In addition, the step S300 in the triggering method of the present embodiment comprises a step S3000: the electronic device 2 detecting whether the physical key 240 is pressed. Specifically, when the physical key 240 is pressed, an interrupt signal is triggered. The electronic device 2 detects whether the physical key 240 is pressed according to whether the interrupt signal is received (i.e. detecting whether the triggering event occurs). Preferably, the electronic device 2 determines that the triggering event occurs when detecting that the physical key 240 is pressed by specific means (such as pressed shortly, pressed for a long time or pressed several times) and matches a predefined condition.

If the electronic device 2 detects that the physical key 240 is pressed, the electronic device 2 determines that the triggering event is detected, and executes step S302. Otherwise, repeatedly executes the step S3000 and continues to detect.

For example, as shown in FIG. 4B, the electronic device 2 is the smart phone, and the physical key 240 is disposed at the left side of the electronic device 2. When the user shortly presses the physical key 240, the interrupt signal is triggered, and the electronic device 2 is enabled to automatically enter the identity authentication mode.

In another example, as shown in FIG. 4C, the electronic device 2 is the smart ring, the physical key 240 is disposed at the surface of the electronic device 2. When the user presses the physical key 240 for a long time, the interrupt signal is triggered, and the electronic device 2 is enabled to automatically enter the identity authentication mode.

Thus, the user is only required to press the physical key 240 with single finger to enable the electronic device 2 entering the identity authentication mode without extra complicated operations.

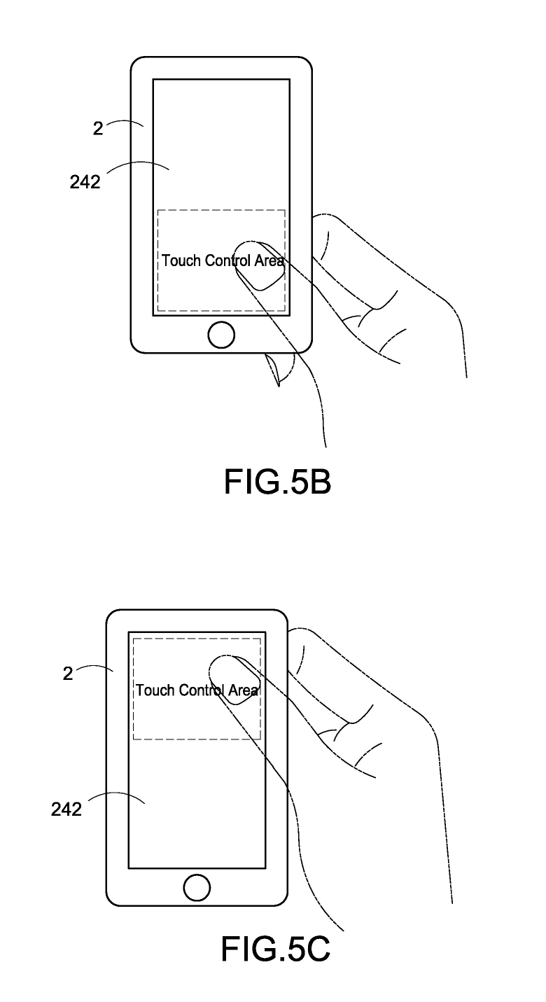

Refer to FIG. 5A, FIG. 5B, FIG. 5C and FIG. 5D, FIG. 5A is a partial flowchart of the triggering method of the third embodiment according to the present invention; FIG. 5B is the first schematic diagram of a triggering event of the third embodiment according to the present invention; FIG. 5C is the second schematic diagram of a triggering event of the third embodiment according to the present invention; and FIG. 5D is the third schematic diagram of a triggering event of the third embodiment according to the present invention.

The difference between the present embodiment and first embodiment is that the input/output unit 24 comprises a touchscreen 242 in the present embodiment.

In addition, the step S300 in the triggering method of the present embodiment comprises a step S3002: the electronic device 2 detecting whether if the touchscreen 242 is pressed. Specifically, when the touchscreen 2 is pressed, an interrupt signal is triggered. The electronic device 2 detects whether the touchscreen 242 is pressed according to whether receiving the interrupt signal (i.e. detecting whether the triggering event occurs). Preferably, the electronic device 2 determines that the triggering event occurs when detecting the touchscreen 242 is pressed by specific means (such as pressed shortly, pressed for a long time, pressed several times, pressed by a holding hand, or pressed by a non-holding hand), or pressed at a specific touch control area (such as an upper part, a lower part, a center or a specific touch control point of the touchscreen 242) and matches a predefined condition.

If the electronic device 2 detecting the touchscreen 242 is pressed, the electronic device 2 determines that the triggering event is detected, and execute step S302. Otherwise, repeatedly execute the step S3002 continue to detect.

For example, as shown in FIG. 5B, the electronic device 2 is the smart phone, and the touch control area is located on the lower part of the touchscreen 242. When the user presses the touch control area with the hand holding the electronic device 2, the interrupt signal is triggered to enable the electronic device 2 automatically entering the identity authentication mode.

In another example, as shown in FIG. 5C, the touch control area is located on the upper part of the touchscreen 242. When the user presses the touch control area with the hand holding the electronic device 2 for a long time, the interrupt signal is triggered to enable the electronic device 2 to automatically entering the identity authentication mode.

In another example, as shown in FIG. 5D, the touch control area is located on the center of the touchscreen 242, the user holds the electronic device 2 with user's holding hand (for example the right hand). When the user uses the non-holding hand (for example left hand) presses the touch control area, the interrupt signal is triggered to enable the electronic device 2 automatically entering the identity authentication mode.

Preferably, the input/output unit 24 also comprises the sensor or the image capturing device, and the electronic device 2 assists with detecting whether the touch control area of the touchscreen 242 is pressed by the holding hand or non-holding hand of the user via the sensor or the image capturing device.

Thus, the user is only required to simply press the touch control area to enable the electronic device 2 entering the identity authentication mode without extra complicated operations.

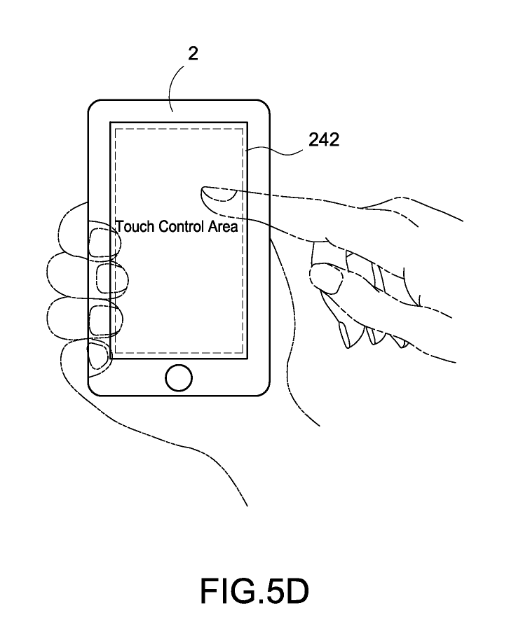

Refer to FIG. 6A and FIG. 6B, FIG. 6A is a partial flowchart of the triggering method of the fourth embodiment according to the present invention, and FIG. 6B is a schematic diagram of a triggering event of the fourth embodiment according to the present invention.

The difference between the present embodiment and first embodiment is that the input/output unit 24 comprises a proximity sensor 244 in the present embodiment. In addition, the step S300 in the triggering method of the present embodiment comprises a step S3004: the electronic device 2 detecting whether the proximity sensor 244 is covered. Specifically, the proximity sensor 244 continues to trigger a distance signal used for representing the distance between an object (such as the user's finger) and the proximity sensor 244. And the electronic device 2 detects whether the proximity sensor 244 is covered according to distance signal (i.e. detects whether the triggering event occurs). Preferably, when the electronic device 2 detects that the distance represented by the distance signal is smaller than a distance threshold (such as 0.2 cm), the electronic device 2 determines that the proximity sensor 244 is covered.

If the electronic device 2 detects the proximity sensor 244 is covered, the electronic device 2 determines that the triggering event is detected, and execute step S302. Otherwise, repeatedly execute the step S3004 continue to detect.

For example, as shown in FIG. 6B, the electronic device 2 is the smart phone, and the proximity sensor 244 is disposed at the upper part of the electronic device 2. When the user uses a finger to cover the proximity sensor 244, the electronic device 2 determines the triggering event occurs according to the distance signal and automatically enters the identity authentication mode.

Thus, the user is only required to cover the proximity sensor 244 with single finger to enable the electronic device 2 entering the identity authentication mode without extra complicated operations.

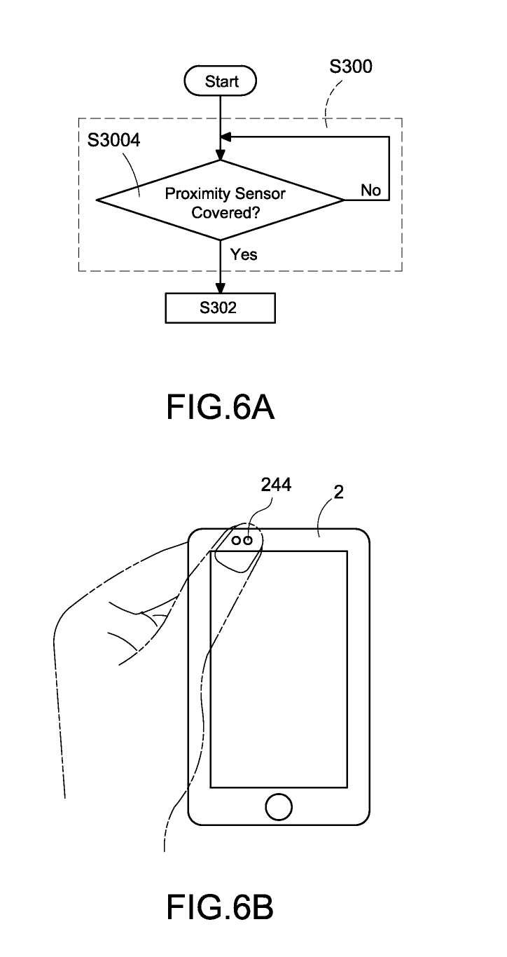

Refer to FIG. 7A and FIG. 7B, FIG. 7A is a partial flowchart of the triggering method of the fifth embodiment according to the present invention, and FIG. 7B is a schematic diagram of a triggering event of the fifth embodiment according to the present invention.

The difference between the present embodiment and first embodiment is that the input/output unit 24 comprises a signal transceiver (such as bluetooth signal transceiver or a Wi-Fi signal transceiver) in the present embodiment. In addition, the step S300 in the triggering method of the present embodiment comprises a step S3006: the electronic device 2 detecting whether the electronic device 2 is moved to a triggering area (such as triggering area Z shown in FIG. 7B).

If the electronic device 2 detects that the electronic device 2 is moved to the triggering area, the electronic device 2 determines that the triggering event is detected, and execute step S302. Otherwise, repeatedly execute the step S3006 continue to detect.

For example, as shown in FIG. 7B, the electronic device 2 is the smart phone, and the triggering area Z is located within a signal transmission range of a signal transmitter 32 (such as a bluetooth signal transmitter or a Wi-Fi signal transmitter). When the user carries the electronic device 2 to move about, and walks into the triggering area Z (i.e. the signal transmission range of the signal transmitter 32), for example, moving from a location 30 outside of the triggering area Z to a location 30 in the triggering area Z, the electronic device 2 receives a triggering signal from the signal transmitter 32 via the signal transceiver (such as a bluetooth signal or a Wi-Fi signal). Next, the electronic device 2 determines that the electronic device 2 is moved to the triggering area Z (i.e. the triggering event occurs) according to the triggering signal, and automatically enters the identity authentication mode.

Thus, the user is only required to move to specific location to enable the electronic device 2 entering the identity authentication mode without any manual operation.

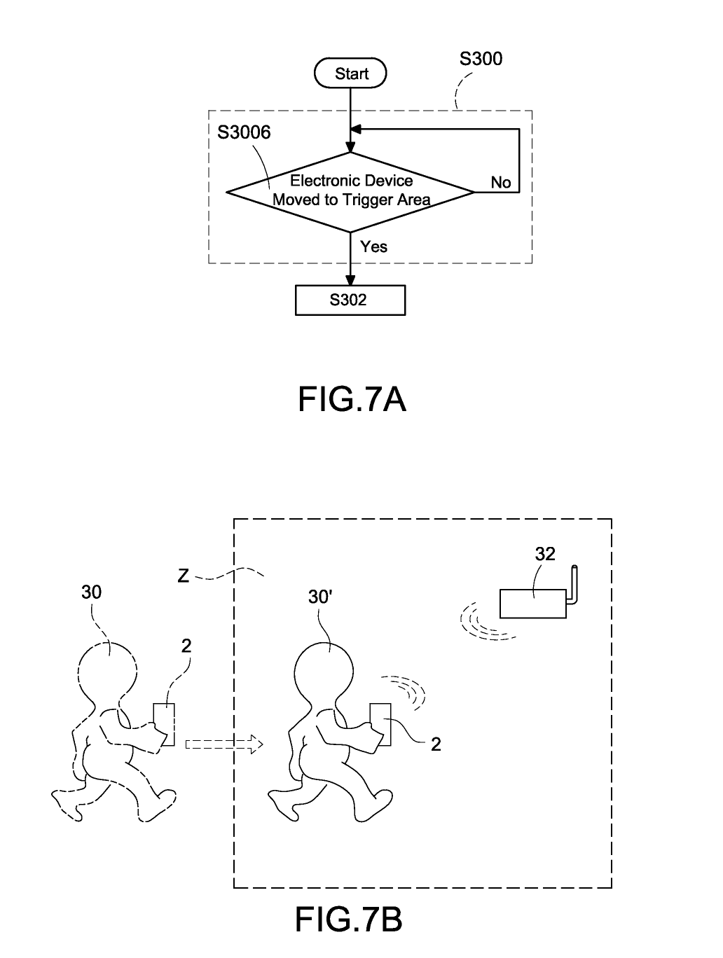

Refer to FIG. 8, FIG. 8 is a partial flowchart of the triggering method of the sixth embodiment according to the present invention.

In the present embodiment the step S3006 in the fifth embodiment is further restricted, and the difference between the present embodiment and fifth embodiment is that the triggering method of the present embodiment comprises following step:

Step S30060: the electronic device 2 receives a location signal from the signal transmitter 32 via the signal transceiver. The location signal is used for representing the current location of the electronic device 2. Preferably, the signal transceiver is a GPS signal transceiver, a Wi-Fi signal transceiver or a mobile network signal transceiver (such as LTE signal transceiver). The location signal is a GPS signal, a Wi-Fi signal or a mobile network signal. The electronic device 2 continues to receive the location signal. The signal transmitter 32 is a GPS satellite, a Wi-Fi access point or a mobile network base station.

Step S30062: the electronic device 2 detecting whether the electronic device 2 is moved to a triggering area Z according to the location signal. Specifically, at least the predefined location data 206 is further saved in the storage unit 20 of the electronic device 2 (the predefined location data 206 can be established previously and saved by the user). The electronic device 2 transforms the received location signal to location data (such as coordinates data), then determines whether the location data matches the predefined location data 206 saved previously.

If matches, the electronic device 2 determines that the electronic device 2 is moved to the triggering area Z, and executes step S302 to enter the identity authentication mode. Otherwise, execute the step S30060 to continue to receive the location signals.

Thus, the user is only required to move to specific location to enable the electronic device 2 entering the identity authentication mode without any manual operation.

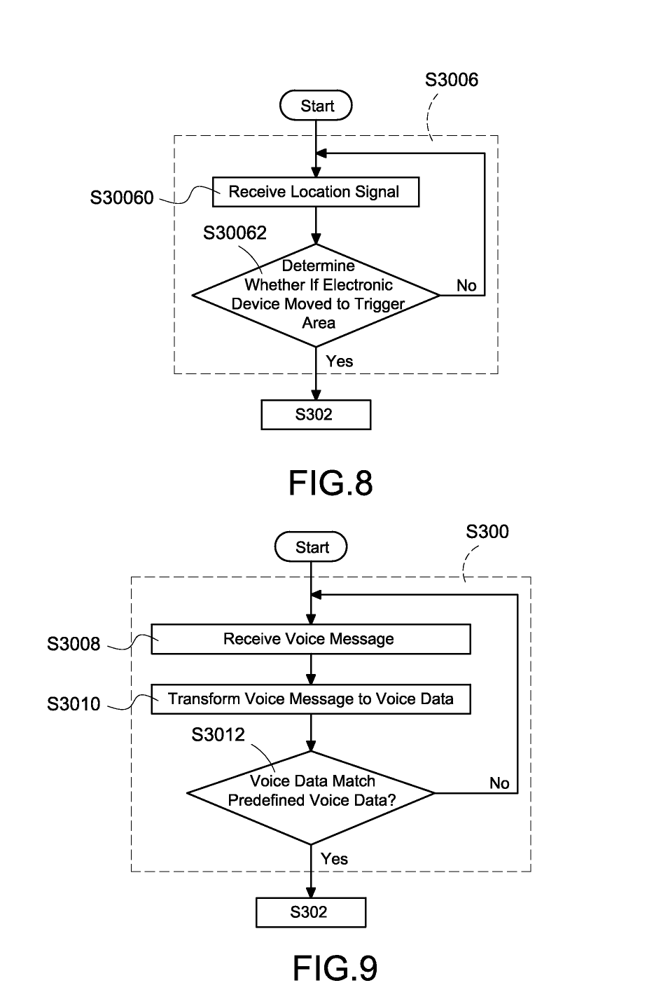

Refer to FIG. 9, FIG. 9 is a partial flowchart of the triggering method of the seventh embodiment according to the present invention.

The difference between the present embodiment and first embodiment is that the input/output unit 24 comprises the microphone, and predefined voice data 208 saved and established previously by the user is saved in the storage unit 20. In addition, the step S300 in the triggering method of the present embodiment comprises following steps:

Step S3008: the electronic device 2 receives a voice message input by the user via the microphone.

Step S3010: the electronic device 2 transforms the received voice message into voice data.

Step S3012: the electronic device 2 detects whether the voice data matches the predefined voice data 208 previously established.

If the electronic device 2 detects the voice data matches the predefined voice data 208, the electronic device 2 determines the triggering event is detected, and executes step S302. Otherwise, repeatedly execute the step S3008 to receive the other voice message.

For example, the electronic device 2 is the smart watch installed with microphone. After the user speaks the voice message “identity authentication” at the microphone, the electronic device 2 generates corresponding voice data “identity authentication”, and performs a comparison with the predefined voice data 208. When the comparison result is a match (i.e., content of the predefined voice data 208 is same with the other voice data “identity authentication” saved by the same user saved previously), the electronic device automatically enters the identity authentication mode.

Thus, the user is only required to input the voice message to enable the electronic device 2 entering the identity authentication mode without any manual operation.

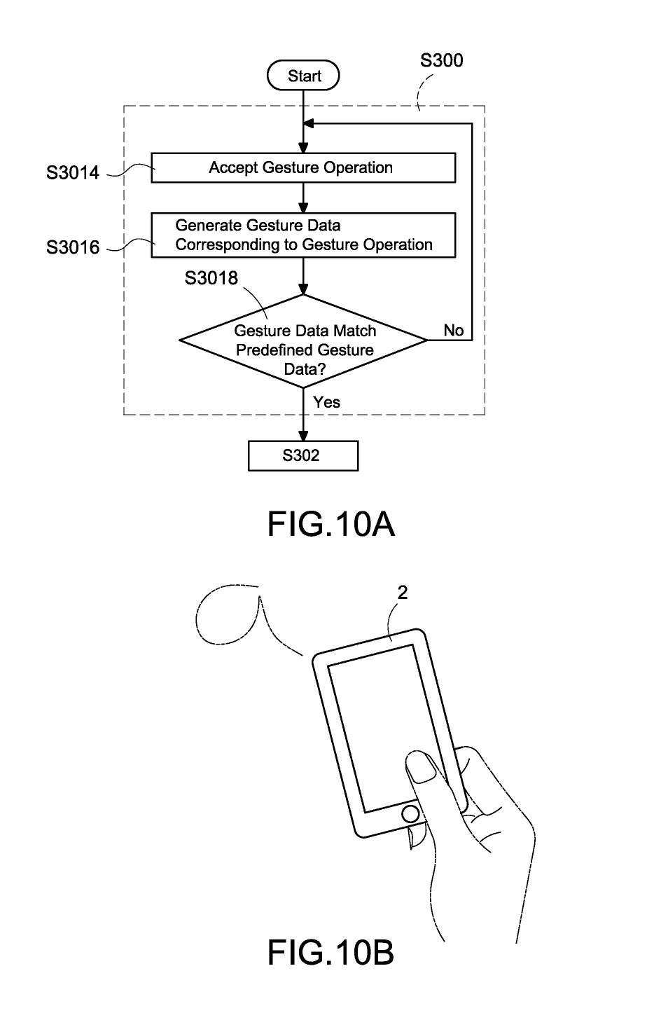

Refer to FIG. 10A and FIG. 10B, FIG. 10A is a partial flowchart of the triggering method of the eighth embodiment according to the present invention, and FIG. 10B is a schematic diagram of a triggering event of the eighth embodiment according to the present invention.

The difference between the present embodiment and first embodiment is that the input/output unit 24 comprises the motion sensor, predefined gesture data 210 saved and established previously by the user is further saved in the storage unit 20. In addition, the step S300 in the triggering method of the present embodiment comprises following steps:

Step S3014: the electronic device 2 accepts a gesture operation. Preferably, the gesture operation is moving the electronic device 2 along a path in the air (in-the-air signature operation hereafter). Specifically, the user takes the electronic device 2 as a pen, and holds the electronic device 2 to write specific symbol or word in the air in order to complete the taking in-the-air signature operation.

Step S3016: the electronic device 2 generates gesture data corresponding to the gesture operation via the motion sensor (such as a plurality of motion sensor values).

Step S3018: the electronic device 2 detects whether the gesture data matches the predefined gesture data 210 previously established.

If the electronic device 2 detects that the gesture data matches the predefined gesture data 210 (i.e., the content of the predefined gesture data 210 is identical with the other gesture data input by the same user via the same taking in-the-air signature operation previously), the electronic device 2 determines the triggering event is detected, and executes step S302. Otherwise, repeatedly execute the step S3014 to receive the other gesture operation.

For example, as shown in FIG. 10B, the electronic device 2 the smart phone installed with a motion sensor. After the user holds the electronic device 2 and write a word “a” in the air (i.e. input the gesture operation), the electronic device 2 generates corresponding gesture data “a”, and performs a comparison between corresponding gesture data “a” with the predefined gesture data 210. The electronic device 2 automatically enters the identity authentication mode when the comparison is a match.

Thus, the user is only required to hold the electronic device 2 and input the gesture operation to enable the electronic device 2 entering the identity authentication mode without extra complicated operations.

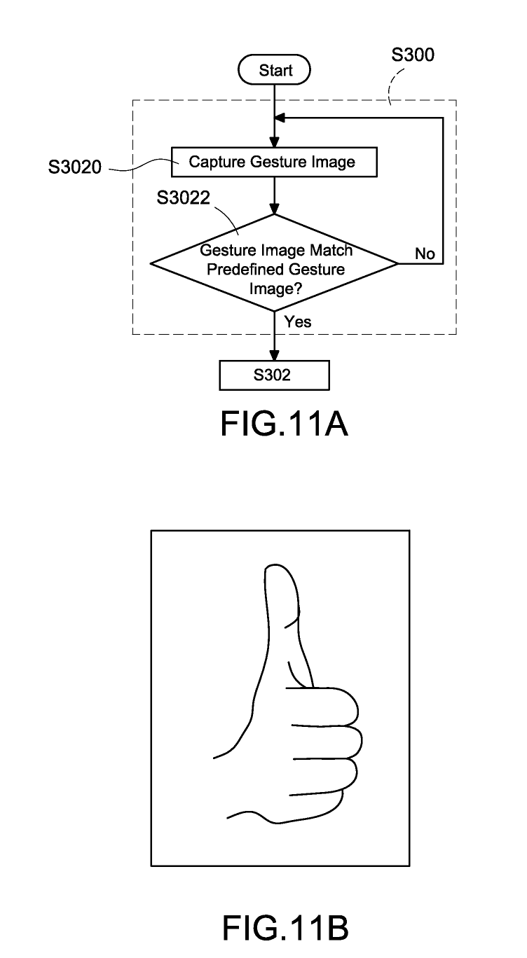

Refer to FIG. 11A, FIG. 11B and FIG. 11C, FIG. 11A is a partial flowchart of the triggering method of the ninth embodiment according to the present invention; FIG. 11B is the first schematic diagram of a triggering event of the ninth embodiment according to the present invention; and FIG. 11C is the second schematic diagram of a triggering event of the ninth embodiment according to the present invention.

The difference between the present embodiment and first embodiment is that the input/output unit 24 comprises the image capturing device, the predefined gesture image 212 saved and established previously by the user is saved in the storage unit 20. In addition, the step S300 in the triggering method of the present embodiment comprises following steps:

Step S3020: the electronic device 2 captures at least one gesture image via the image capturing device.

For example, the user poses a static gesture in front of the image capturing device as the gesture operation (for example sticking out the thumb). Next, the image capturing device performs single image capturing operation on the gesture and generates the single gesture image as shown in FIG. 11B.

In another example, the user poses a static gesture in front of the image capturing device as the gesture operation (for example sticking out the thumb, the index finger and all fingers). Next, the image capturing device performs consecutive image capturing operation on the gesture and generates a plurality of the gesture images as shown in FIG. 11C.

Step S3022: the electronic device 2 detects whether the gesture image matches the predefined gesture image 212 previously established.

If the electronic device 2 detects the gesture image matches the predefined gesture image 212 previously established, it is determined that the triggering event is detected, and the method moves to execute step S302. Otherwise, repeatedly execute the step S3020 to retrieve the other gesture operation.

Thus, the user is only required to pose a gesture to enable the electronic device 2 entering the identity authentication mode without extra complicated operations.

It should be noted that, the example used in the present embodiment is the image capturing device which is directly disposed in the electronic device 2, but the scope is not limited thereto.

In another embodiment of the present invention, the electronic device 2 is externally connected to the image capturing device via wired or wireless connection, and obtains the gesture image from the image capturing device.

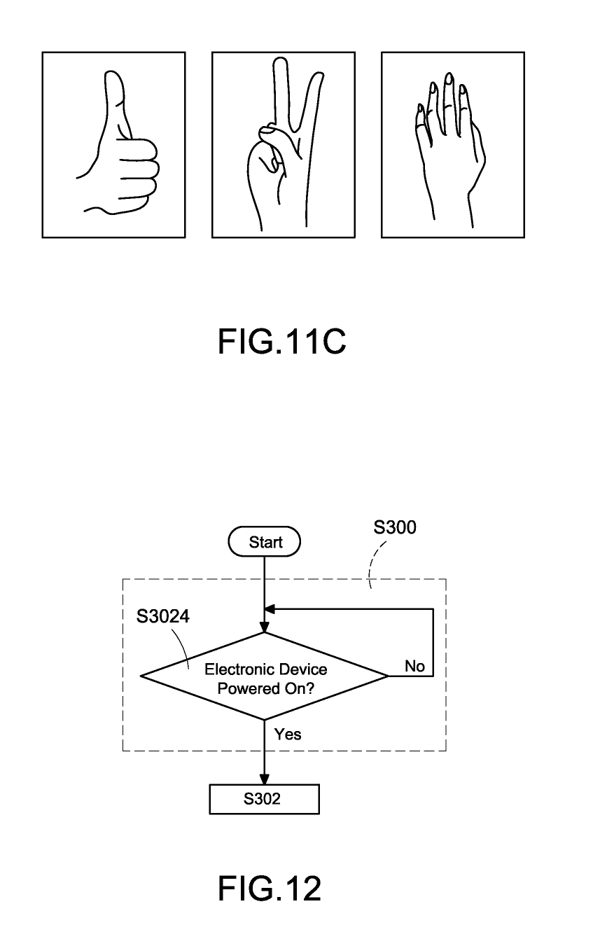

Refer to FIG. 12, FIG. 12 is a partial flowchart of the triggering method of the tenth embodiment according to the present invention.

The difference between the present embodiment and first embodiment is that the electronic device 2 automatically enters the identity authentication mode after powering on in the present embodiment.

Specifically, the step S300 in the triggering method of the present embodiment comprises a step S3024: the electronic device 2 detecting whether the electronic device 2 is powered on.

If the electronic device 2 detects that the electronic device 2 is powered on by the user, the electronic device 2 determines that the triggering event is detected and executes step S302. Otherwise, repeatedly execute the step S3024 to continue to detect.

Thus, after the electronic device 2 is powered on, the electronic device 2 automatically enters the identity authentication mode, and the user is allowed to directly perform identity authentication associated functions anytime without extra complicated operations.

As the skilled person will appreciate, various changes and modifications can be made to the described embodiment. It is intended to include all such variations, modifications and equivalents which fall within the scope of the present invention, as defined in the accompanying claims.

What is claimed is:

1. A method of triggering an identity authentication mode of an electronic device, comprising following steps:
a) when detecting a triggering event, automatically entering the identity authentication mode;
b) accepting a user operation under the identity authentication mode;
c) generating input data corresponding to the user operation;
d) if the input data is determined matching one of a plurality of predefined input data established previously, authenticating a user identity, and obtaining a control command matching the predefined input data; and
e) executing the control command.

2. The method of triggering the identity authentication mode of the electronic device of claim 1, wherein the step a comprises a step a11: when detecting a physical key of the electronic device being pressed, entering the identity authentication mode.

3. The method of triggering the identity authentication mode of the electronic device of claim 1, wherein the step a comprises following steps:
a21) detecting whether a touchscreen of the electronic device is pressed; and
a22) when detecting the touchscreen being pressed, entering the identity authentication mode.

4. The method of triggering the identity authentication mode of the electronic device of claim 3, wherein the step a21 is detecting whether a touch control area on bottom half of the touchscreen is pressed.

5. The method of triggering the identity authentication mode of the electronic device of claim 3, wherein the step a21 is detecting whether the touchscreen is pressed by a non-holding hand of the user.

6. The method of triggering the identity authentication mode of the electronic device of claim 3, wherein the step a21 is detecting whether a touch control area on upper half of the touchscreen is pressed for a long time.

7. The method of triggering the identity authentication mode of the electronic device of claim 1, wherein the step a comprises a step a31: when a proximity sensor of the electronic device is detected being covered, entering the identity authentication mode.

8. The method of triggering the identity authentication mode of the electronic device of claim 1, wherein the step a comprises a step a41: when the electronic device is detected to be moved to a triggering area, entering the identity authentication mode.

9. The method of triggering the identity authentication mode of the electronic device of claim 8, wherein the step a41 is when receiving a triggering signal from a signal transmitter disposed in the triggering area, the electronic device is determined to be moved to the triggering area and entering the identity authentication mode.

10. The method of triggering the identity authentication mode of the electronic device of claim 9, wherein the triggering signal is a bluetooth signal or a Wi-Fi signal.

11. The method of triggering the identity authentication mode of the electronic device of claim 8, wherein the step a41 comprises following steps:
a411) receiving a location signal; and
a412) when the electronic device is detected to be moved to a triggering area according to the location signal, entering the identity authentication mode.

12. The method of triggering the identity authentication mode of the electronic device of claim 11, wherein the location signal is a GPS signal, a Wi-Fi signal or a mobile network signal.

13. The method of triggering the identity authentication mode of the electronic device of claim 1, wherein the step a comprises following steps:
a51) receiving a voice message;
a52) transform the voice message to voice data; and
a53) when the voice data is detected matching predefined voice data previously established, entering the identity authentication mode.

14. The method of triggering the identity authentication mode of the electronic device of claim 1, wherein the step a comprises following steps:
a61) accepting a gesture operation;
a62) generating gesture data corresponding to the gesture operation; and
a63) when the gesture data is detected matching predefined gesture data previously established, entering the identity authentication mode.

15. The method of triggering the identity authentication mode of the electronic device of claim 14, wherein the gesture operation is moving the electronic device along a path in the air.

16. The method of triggering the identity authentication mode of the electronic device of claim 1, wherein the step a comprises following steps:
a71) capturing at least a gesture image via an image capturing device; and
a72) when the gesture image is detected matching the predefined gesture image previously established, entering the identity authentication mode.

17. The method of triggering the identity authentication mode of the electronic device of claim 16, wherein the step a71 is capturing a static gesture of the user for capturing the single gesture image.

18. The method of triggering the identity authentication mode of the electronic device of claim 16, wherein the step a71 is capturing a dynamic gesture of the user for capturing a plurality of the gesture images.

19. The method of triggering the identity authentication mode of the electronic device of claim 1, wherein the step a comprises a step a81: when the electronic device is detected powered on, entering the identity authentication mode.

20. The method of triggering the identity authentication mode of the electronic device of claim 1, wherein the method further comprises a step f after the step a: sending a message of entering the identity authentication mode.
